(19) United States
(12) Patent Application Publication
(10) Pub. No.: US 2024/0280759 A1
(43) Pub. Date: Aug. 22, 2024

(54) OPTICAL CONNECTOR ASSEMBLY

(71) Applicants: Molex, LLC, Lisle, IL (US); Kyocera SLD Laser, Inc., Goleta, CA (US)

(72) Inventors: Andrew Karl Eckhart, Lombard, IL (US); Thomas R. Marrapode, Naperville, IL (US); Wenzong Chen, Naperville, IL (US); Terrence Wayne Towe, Tucson, AZ (US); Richard A. Trejo, JR., Tucson, AZ (US); Daming Liu, Tucson, AZ (US)

(21) Appl. No.: 18/408,580

(22) Filed: Jan. 10, 2024

Related U.S. Application Data
(60) Provisional application No. 63/447,309, filed on Feb. 21, 2023.

(51) Int. Cl. G02B 6/38

(52) U.S. Cl. CPC G02B 6/3814; G02B 6/3849; G02B 6/3893

(57) ABSTRACT

An optical connector assembly includes a housing having a mating end shaped to receive an input connector. The housing also has an output end opposite the mating end. A ferrule is disposed within the housing and at least a portion of an optical cable is secured within the ferrule. A plug body is disposed within the housing and in thermal contact with the ferrule and having a plug-body front face. A thermal pad may include a thermal-pad rear face and a thermal-pad front face. The thermal-pad rear face may contact the plug-body front face, and the thermal-pad front face may contact the input connector when the input connector is mated with the optical connector assembly.

### CROSS-REFERENCE TO RELATED APPLICATION

This application claims priority to and the benefit of U.S. Provisional Patent Application No. 63/447,309 filed Feb. 21, 2023. The entire disclosure of this provisional patent application is incorporated herein by reference.

### FIELD OF THE DISCLOSURE

This disclosure generally relates to an optical connector assembly, and, in some embodiments, particularly to optical connector assemblies with thermal pad for thermal management.

### BACKGROUND

In automobile applications, connectors need to be sealed to protect the internal data transmission line (e.g., wire or fiber) from external elements (water, dust, chemicals, etc.). Optical signals are becoming more popular in automobile applications, such as for providing decorative lighting and also for optical signal communication between the automobile and an external device (e.g., another automobile, or streetlight, or building, etc.).

Optical signals may be transported by transmitting light through an optical cable containing one or more fibers. In an optical link, connector ferrules position a fiber or bundle of fibers precisely in front of the light producing or light receiving elements and light travels within the fiber(s). Coupling light energy into a fiber core or bundle can generate excessive heat since light that is not fully coupled or mode-matched to the fiber will eventually escape the core and cladding, where it will be absorbed by the surrounding materials and converted into heat. Furthermore, the high light energy forms heat at the tip of the fiber face and at critical power levels cause dust and other debris to be burned onto the tip. This burned debris reduces optical transmission, thereby reducing coupling efficiency and causing additional increases in temperature via thermal runaway.

### SUMMARY

The following aspects provide example feature combinations of embodiments of the present disclosure. The disclosure is not limited to only these combinations of features, and other aspects may include more or different features than those discussed in this summary section.

In some aspects, an optical connector assembly includes a housing having a mating end shaped to receive an mating receptacle and an output end opposite the mating end. The optical connector assembly also includes a ferrule disposed within the housing, at least a portion of an optical cable secured within the ferrule, a plug body in thermal contact with the ferrule and having a plug-body front face, the plug-body front face being configured to interface with a thermal pad having a thermal-pad rear face and a thermal-pad front face. When in use, the thermal-pad rear face contacts the plug-body front face. The thermal-pad front face contacts the input connector while the input connector is mated to the optical connector assembly.

In any of the above aspects, the thermal pad is made from one or more of silicone, silicone rubber, fiberglass, and composites thereof.

In any of the above aspects, the ferrule is shaped as a cylinder and the thermal pad is shaped as an annulus that encircles the ferrule.

In any of the above aspects, the plug body defines a channel that extends axially inward from the plug-body front face such that a portion of the ferrule is disposed in the channel.

In any of the above aspects, a spring is secured within the housing and configured to bias the plug body towards the mating end of the housing.

In any of the above aspects, the plug body forms a plug-body flange against which the spring exerts a force to bias the plug body towards the mating end of the housing.

In any of the above aspects, the housing further includes a stop surface, wherein movement of the plug body toward the mating end of the housing is limited by the stop surface

In any of the above aspects, a back body is located at the output end of the housing, wherein the optical cable (or portion thereof) passes through the back body.

In any of the above aspects, a sealing member is located between the optical cable (or portion thereof) and the back body.

In any of the above aspects, a sealing member is located between the back body and the housing.

In any of the above aspects, a first sealing member is located between the optical cable (or portion thereof) and the back body. Furthermore, a second sealing member is located between the back body and the housing.

In any of the above aspects, one or both of the first and second sealing members is an O-ring.

In any of the above aspects, the plug body defines a plug-body channel, a first portion of the optical cable that is located within the plug-body channel is bare an outer fiber jacket surrounding at least one optical fiber, and a second portion of the optical cable that is located within the plug-body channel includes the outer fiber jacket.

In any of the above aspects, the first portion and the second portion of the optical cable includes an inner fiber jacket surrounding the at least one optical fiber core.

In any of the above aspects, a portion of the at least one optical fiber is located within the ferrule and bare of the inner fiber jacket and the outer fiber jacket.

In any of the above aspects, the ferrule and the plug body are monolithic.

In any of the above aspects, the ferrule and the plug body are non-monolithic (i.e., physically separate components).

In any of the above aspects, internal components of the housing are sealed to external elements.

In any of the above aspects, the housing conforms to an automobile connector.

In any of the above aspects, the thermal pad is a component of the optical connector assembly.

In any of the above aspects, the thermal pad is a component of the input connector.

In any of the above aspects, one or more of the spring constant of spring, the thickness of thermal pad, the compression constant of thermal pad, and other characteristics of the spring and thermal pad are selected based on the required tolerance of the position of the end face of the ferrule or fibers relative to a designed reference plane or focal point.

In any of the above aspects, the optical cable having a core or bundle of light guiding or light emissive fibers.

### BRIEF DESCRIPTION OF THE DRAWINGS

FIG. 1 shows a top perspective view of an optical connector assembly coupled with an optical cable, in embodiments.

FIG. 2 shows a sectional view depicting the internal components of the optical connector assembly, in embodiments.

FIG. 3 shows a perspective view of the optical connector assembly of FIGS. 1 and 2, with the outer housing removed, in embodiments.

FIG. 4 shows a perspective view of an embodiment of the optical connector assembly, but without the latch lock.

FIG. 5 shows a sectional view of the embodiment of the optical connector assembly of FIG. 4, but also showing the ferrule separate and distinct from the plug body.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements and are not drawn to scale. Moreover, the drawings are intended to show features that are included in some embodiments, but not included in others. Therefore, those of ordinary skill in the art understand that not every feature shown or described are required for each and every embodiment of the present application, unless otherwise indicated.

Optical connections in sealed components provide a difficult problem to overcome. Heat generated at the connection interface may need to be dissipated. In sealed-plastic connectors, this problem is amplified because the heat, particularly in high light energy devices, can cause damage to the fiber tip or degrade materials such as epoxies, fiber claddings, ferrule materials or connector components

Embodiments herein disclose an optical connector assembly that is particularly useful with operating light generating devices generate high levels of heat at interfaces between the optical connector and/or an input connector. By using a ferrule and plug-body configuration in combination with a thermal pad, as discussed below, the embodiments herein provide the advantage of transferring heat out through the input connector back into the device receptacle or housing, thereby preventing thermal damage to various material in the connector. As an example, where the input optical signal is laser light, ample amounts of heat are generated at the interface of the fiber(s) face within a ferrule of the embodiments of the optical connector discussed herein and the input connector. Moreover, this advantage is amplified when the housing of the optical connector is sealed, such as using sealing members as discussed herein. Sealed connectors (and more so plastic sealed connectors) are not able to dissipate the heat in an efficient manner because of the connector cavity which the ferrule and plug body sit within are insulated within the connector hosing. Accordingly, the present embodiments resolve these technical problems by providing a solution to thermal management via the ferrule, plug body, and thermal pad configuration discussed herein.

Advantageously, the thermal pad characteristics discussed herein provide the advantage of allowing lower machining tolerances during manufacturing of internal parts (e.g., the plug body front face discussed herein). For example, this thermal pad allows for sufficient contact between the surfaces of the internal thermal-management components (e.g., the plug body and the internal connector) to overcome lower machining tolerances.

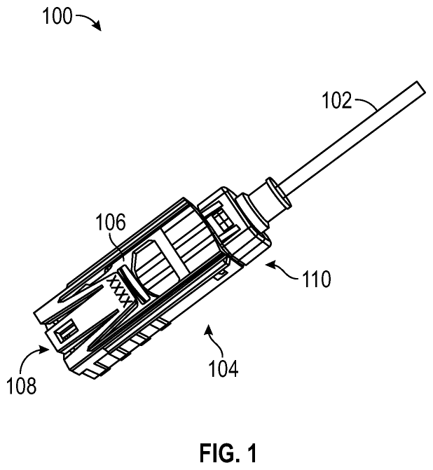

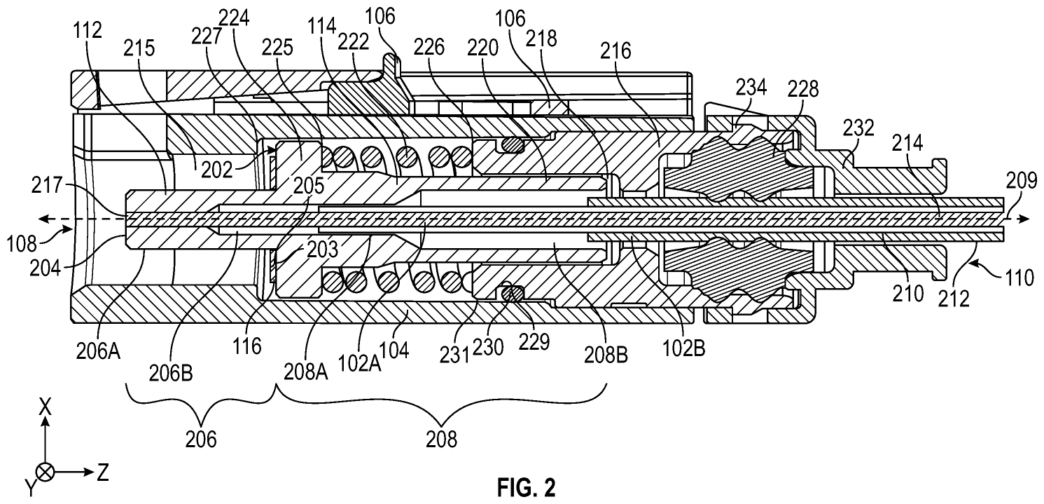

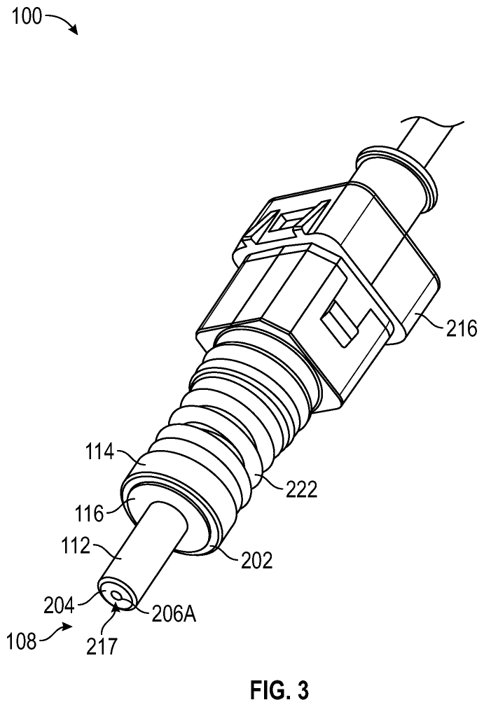

FIG. 1 is a top perspective view of an optical connector assembly 100 with an optical cable 102, in embodiments. FIG. 2 is a cross-sectional view depicting internal components of the optical connector assembly 100, in embodiments. FIG. 3 is a perspective view of the optical connector assembly 100 of FIGS. 1 and 2 with the outer housing removed, in embodiments. FIGS. 1-3 are best viewed together with the following description.

Optical connector assembly 100 includes a housing 104 that is sized and shaped according to an automobile style connector, in an embodiment. Optical connector assembly 100 may be sized and shaped according to connectors used in other applications as well, such as, but not limited to, airplane connectors, marine connectors, consumer electronics connectors, data center connectors, computing connectors, and industrial connectors.

The housing 104 may include a latch and latch lock 106 that locks the optical connector assembly 100 in connection with a corresponding input connector (not shown), when the input connector is engaged at a mating end 108 of the housing 102 of the optical connector assembly 100. The optical cable 102 exits the output end 110 of the housing 104. In embodiments, light input into optical cable 102 may be used to illuminate optical cable 102 and provide decorative lighting throughout the mounted structure (e.g., an automobile decorative lighting). Furthermore, in embodiments, light input into the optical cable 102 may be modulated to provide optical communication signal output from the optical cable 102 to an external device, such as another automobile, streetlight, or other device having an optical receiver. In embodiments, light input into optical cable 102 may be of a wavelength corresponding to visible or non-visible light. In embodiments, light input into optical cable 102 may be laser light.

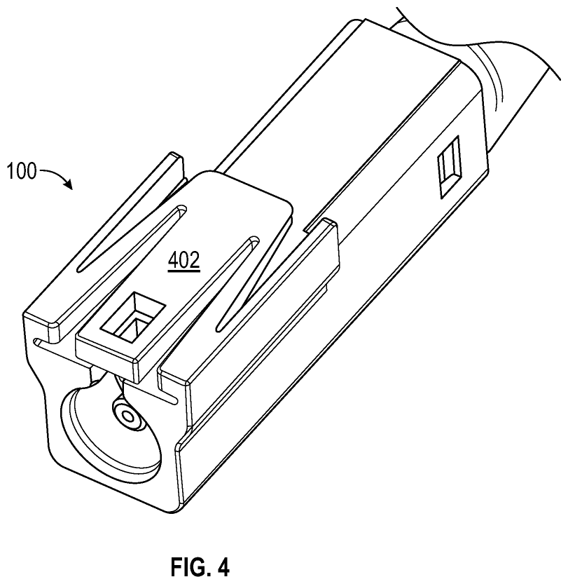

Latch and lock 106 is optional. Other mechanisms for connection to an input connector may be implemented as well, such as other latches, latch configurations, snap fit configurations, screw on and other mechanisms. FIG. 4 shows a perspective view of an embodiment of the optical connector assembly 100, including a latch 402 but without the latch lock 106.

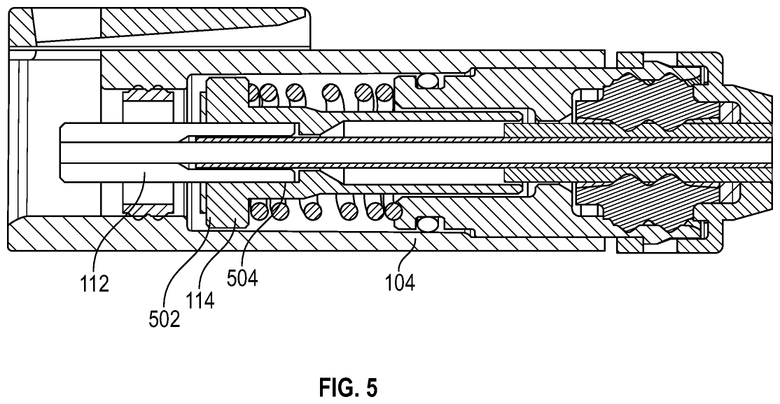

A ferrule 112 is disposed within the housing 104. Ferrule 112 is in thermal contact with a plug body 114. Thermal contact may be achieved where ferrule 112 is integral with the plug body 114, in embodiments. However, in embodiments, ferrule 112 may be a separate component from the plug body 114, such as shown in FIG. 5, but still achieve thermal contact via the ferrule 112 directly contacting the plug body 114. “Directly” such as “directly contacting” as used herein means contacting without any intervening components (e.g., an interference fit). In embodiments, ferrule 112 may be a separate component from the plug body 114, such as shown in FIG. 5, but still achieve thermal contact via the ferrule 112 contacting the plug body 114 with one or more intermediate components (such as an adhesive layer, a coating, or some other intermediate component) that allow for thermal conduction from the ferrule 112 to the plug body 114.

FIG. 5 shows a sectional view of the embodiment of the optical connector assembly 100 of FIG. 4, but also showing a ferrule 112 separate and distinct (e.g., non-monolithic) from the plug body 114. The plug body 114 defines a cavity 504 that extends inward from a surface 502 of the plug body 114. The cavity 504 may have an inner shape that corresponds to the outer profile of the ferrule 114. For example, the ferrule 112 may be a cylindrical shape and the cavity 504 may be a corresponding hollow cylindrical shape. The ferrule 112 may be retained in the cavity 504 of plug body 114 using mechanical, adhesive, or other retention methods. In embodiments including an adhesive, the adhesive may be located at the interface of ferrule 112 and plug body 114. For example, an adhesive may be placed onto the outer surface of the ferrule 112 and/or inner surface of cavity 504, and then the ferrule 112 is press-fit into the cavity 504.

Optical connector assembly 100 further includes a thermal pad 116. In use, a rear face 203 of the thermal pad 116 rests against a front face 202 of the plug body 116. A front face 205 of the thermal pad 116 is then contacted with the input connector (not shown) when the input connector is mated to the optical connector assembly 100. Thermal pad 116 is shown as being a component of optical connector assembly 100; however, the thermal pad 116 may be a component of the input connector without departing from the scope hereof. Thermal pad 116 comprises a material including one or more of silicone, silicone rubber, fiberglass, and composites thereof (such as but not limited to fiberglass reinforced silicone). Thermal pad 116 may be a thermal pad commercially sold and marketed. In an embodiment, the ferrule 112 is shaped as a cylinder, and the thermal pad 116 is shaped as an annulus that encircles the ferrule 112. Thermal pad 116 operates to remedy contact imperfections between the plug body 114 and the input connector (not shown) when the input connector is mated with the optical connector assembly 100 (e.g., engaged with the housing 102). Thermal conduction between plug body 114 and input connector, if they were in direct contact, would not be efficient. This is because imperfections during manufacturing, and wear and tear of the product, lower the ability of the plug body 114 and input connector to engage properly to allow for effective heat transfer therebetween. For example, the manufacturing tolerances may result in a front face 202 of the plug body 114 to be slightly angled with respect to a face of the input connector. Moreover, during operation, the front face 202 may become scratched or otherwise warped, worn, etc. to hindering precise abutting of the front face 202 of the plug body 114 to the input connector over a large surface area. Use of the thermal pad 116 overcomes these imperfections during manufacturing and wear and tear of the product by buffering the contact between the plug body 114 and the input connector to improve efficiency of the thermal conduction from the ferrule 112, through the plug body 114, and out of the optical connector assembly 100 through the input connector. In embodiments, the thermal pad 116 has a thermal conductivity greater than that of air at room temperature (i.e., greater than 0.025 W/(m·K)). In embodiments, the thermal pad 116 has a thermal conductivity between 0.03 and 2 W/(m·K). In embodiments, the thermal pad 116 has a thermal conductivity between 0.03 and 2 W/(m·K).

Referring to FIGS. 2 and 3, the front face 202 of the plug body 114 faces the input connector. The ferrule 112 further defines a ferrule channel 206 (shown including first ferrule-channel portion 206A and second ferrule-channel portion 206B) that extends axially inward from a ferrule front face 204. The plug body 114 defines a plug-body channel 208 (shown including first plug-body channel portion 208A and second plug-body channel portion 208B) that extends axially inward from plug-body front face 202 towards output end 110 of the housing 104. The braces denoting reference numeral for ferrule channel 206 are shown generally corresponding to the length of each first ferrule-channel portion 206A and second ferrule-channel portion 206B, however the length of the ferrule channel 206, or portions thereof, may be longer or shorter, and the diameter may be wider or narrower without departing from the scope hereof. The braces denoting reference numeral for plug-body channel 208 are shown generally corresponding to the length of each first plug-body-channel portion 208A and second plug-body-channel portion 208B, however the length of the plug-body channel 208, or portions thereof, may be longer or shorter, and the diameter may be wider or narrower without departing from the scope hereof.

Ferrule channel 206 and plug-body channel 208 are co-axial, and optical cable 102 passes through each of the ferrule channel 206 and plug-body channel 208. In embodiments, such as that shown in FIG. 5, where the ferrule 112 and plug body 114 are monolithic, the ferrule channel 206 and plug-body channel 208 are continuous and adjacent to one another. Ferrule channel 206 and plug-body channel 208 may be formed by drilling within a pre-formed ferrule 112 and/or plug body 114, respectively. Ferrule channel 206 includes a first ferrule-channel portion 206A and a second ferrule-channel portion 206B having greater diameter than the first ferrule-channel portion 206A. First ferrule-channel portion 206A is the portion of ferrule channel 206 towards input-end 108 of housing 104. Second ferrule-channel portion 206B is adjacent first ferrule-channel portion 206A towards output end 110 of housing 104. Plug body channel 208 is adjacent ferrule channel 206 towards output end 110 of housing 104. First plug-body-channel portion 208A is the portion of plug-body channel 208 towards input-end 108 of housing 104. Second plug-body-channel portion 208B is adjacent first plug-body-channel portion 208A towards output end 110 of housing 104.

Plug-body channel 208 includes a first plug-body-channel portion 208A and a second plug-body-channel 208B having greater diameter than the first plug-body-channel portion 208A. The first ferrule-channel portion 206A and the first plug-body-channel portion 208A have the same diameter. Different dimensions (length, width, diameter, etc.) of the first ferrule-channel portion 206A, second ferrule-channel portion 206B, first plug-body-channel portion 208A, and second plug-body-channel portion 208B, and more or fewer portions of the ferrule channel 206 and plug body channel 208 may be implemented without departing from the scope hereof.

Fiber core 214 is disposed at the mating end (e.g., front face 204) of the ferrule 112 with the first ferrule-channel portion 206A and the second ferrule-channel portion 206B bare of both an inner fiber jacket 210 and an outer fiber jacket 212. A first portion 102A of the optical cable 102 is shown in first plug-body-channel portion 208A and second ferrule-channel portion 206B bare of the outer fiber jacket 212 but including the inner fiber jacket 210. A second portion 102B of optical cable 102 within second plug-body-channel portion 208B includes the inner jacket 210 and the outer jacket 212. In some embodiments, there may be one jacket instead of two distinct jackets. The second portion 102B may further extend out of the housing 104 at output end 110. The portions of optical cable 102 including inner jacket 210 and outer jacket 212 may vary other than those shown. For example, a portion of optical cable 102 having the inner jacket 210 may extend into second ferrule-channel portion 206B without departing from the scope hereof. By stripping the optical cable 102 to its fiber core 214 at the mating end of the ferrule 112, a balance between alignment of the optical cable 102 to the input source on the input connector, case of manufacturing (e.g., inputting the optical cable 102 within the ferrule channel portion 206, and efficient thermal conduction from the fiber core 214 to the ferrule 112, and then to the plug body 114 is achieved. Fiber core 214 may have core diameter greater than or equal to 125 microns, although other dimensions less than 125 microns may be used without departing from the scope hereof.

As shown by arrow 215 in FIG. 2, heat generated at the ferrule 112 (e.g., at the interface of fiber core 214 and ferrule 112 body, or at the interface of ferrule 112 and the input connector (not shown), or that the interface of the input face 217 of fiber core 214 and input light source (not shown)) dissipates through plug body 114 and then back into the input connector via the thermal pad 116. Thus, the ferrule 112, plug body 114, and thermal pad 116 are in thermal contact with one another, and the thermal pad 116 is in thermal contact with the input connector when the input connector is mated with the optical connector assembly 100.

Optical connector assembly 100 further includes a back body 216 affixed to the housing 104 at an output end 110 of the housing 104. The optical cable 102 may pass through the back body 216. Back body 216 may define a back-body channel 218 that a back-end portion 220 of the plug body 114 is disposed in. The plug body 114 may be able to move axially within the back-body channel 218. For example, a spring 222 may be disposed to encircle the plug body 114 between a plug-body flange 224 (e.g., rear surface 225 thereof) of the plug body 114 and a back-body front face 226. Spring 222 is thus disposed within the housing 104 and configured to bias the plug body 114 towards the mating end 108 of the housing 104. In an embodiment, the plug body 114 includes the plug-body flange 224 against which the spring 222 exerts a force to bias the plug body 114 towards the mating end 108 of the housing 104.

One or more of the spring constant of spring 222, the thickness of thermal pad 116, the compression constant of thermal pad 116, and other characteristics of spring 222 and thermal pad 116 are selectable based on the required tolerance of alignment of the input face 217 of fiber core 214 with the desired optical reference plane. In embodiments where input connector is a separate connector, this alignment may be to a separate fiber core in the input connector, the desired optical reference plane may be the separate fiber core or face thereof. However, in embodiments where alignment of two fiber cores is not required (e.g., where the input connector is a separate device that focuses light onto the fiber face 217), the desired optical reference plane may be the focal point or focal plane designated by the input connector. The input connector, which may be a separate connector or a device housing (or other component), engages with the optical connector assembly 100 via coupling of the optical connector assembly 100 and the input connector along mating axis 209. When the input connector engages with the optical connector assembly 100, front face 204 of ferrule, and input face 217 of the fiber face 214, respectively mate (come into contact with) ferrule and input fiber core of the input connector along mating axis 209. The ferrule 112, and thus the input face 217 of the fiber core 214 therein, needs to have proper alignment with the input connector to allow light to properly transfer into the optical cable 102 (e.g., fiber core 214) from the input connector. In one embodiment, ferrule face position tolerance is ±50 μm in the X-Y plane shown in FIG. 2. A plurality of properties of the thermal pad 116 or other components of the connector impact the ability to properly align the fiber core 214 to the input connector, such as but not limited to the thickness of the thermal pad 116, compression constant of the thermal pad 116, heat transfer characteristics of the thermal pad 116 under various compression loads, the spring constant of the spring 222, and more. These properties are engineered and/or adjusted with respect to one another to maintain proper positioning of the fiber core 214 with respect to the input connector. For example, if the thermal pad 116 is too thin, then there may not be good contact with either front face 202 or the face of the input connector to achieve the desired thermal contact and thermal conduction. Moreover, spring constant and thermal pad characteristics can impact the vibration resistance. Vibration resistance is particularly important in applications where the mounted structure is a moving structure, such as automotive, airplane, and/or marine applications.

The housing 104 may define a stop surface 227 proximate the front face 202 or flange 224 of the plug body 114 when the plug body 114 is installed within the housing 104. Movement of the plug body 114 towards the mating end 108 may be limited by the stop surface 227 (e.g., when the flange 224 or front face 202 abuts the stop surface 226. A diameter of the flange portion 224 of the plug body 114 may be greater than the diameter of the ferrule 112, and the thermal pad 116. The stop surface 227 is sized and shaped with respect to the diameter of the flange portion 224 so that the flange portion 224 abuts the stop surface 227 to prevent movement of the plug body 114 towards the mating end 108 in response to spring force from spring 222. An inner diameter of the housing 104 towards the mating end 108 from the stop surface 226 may be greater than the diameter of the thermal pad 116 to allow the thermal pad 116 to be pushed in the Z direction past the stop surface 227, but the front surface 202 of the flange 224 to be adjacent towards the output end 110 at an X-Y plane defined at the stop surface 227.

In embodiments, internal components of the housing 104 (e.g., the ferrule 112, the plug body 114, the spring 222, the back body 216, and other components described herein) are sealed to external elements (e.g., moisture, dust, etc.). For example, in one embodiment, a first scaling member 228 may be within back body 216 encircling the optical cable 102. In an additional or alternative embodiment, a second sealing member 230 is located between the back body 216 and the housing 104. Second sealing member 230 may encircle the back body 216 and located in a sealing groove 229 defined in an outer surface 231 of back body 216. If included, adhesive used to affix the front plate 216 to the housing 104 may also serve to seal the interior of the housing 104 at contact location of the front plate 216 and the housing 104. However, adhesive is not included in all embodiments, such as those where back body 216 is snap fit with housing 104. Furthermore, in an additional or alternative embodiment, the input connector may include a sealing member that is located proximate to the input connector housing and the housing 104 when the input connector is engaged to the housing 104. The sealing member may encircle the mating end, or otherwise be located to provide said seal. Each of the sealing members 228 and 230 may be a single O-ring or a dual O-ring, or double hump seal. More or fewer sealing members may be utilized without departing from the scope hereof.

Back body 216 is shown coupled to an end cap 232. End cap 232 may have a snap-fit connection at attachment location 234 to the back body 216. End cap may be flexible so as to prevent damaging bending of optical cable 102 at location of output end 110. First sealing member 228 may contact an inner surface of end cap 232 to provide moisture barrier between the end cap 232 and optical cable 102 and/or back body 216.

The present embodiments are not limited in any way to the illustrated embodiments. Instead, the illustrated embodiments described below are merely examples. Therefore, the structural and functional details disclosed herein are not to be construed as limiting the claims. The disclosure merely provides bases for the claims and representative examples that enable one skilled in the art to make and use the claimed inventions. Furthermore, the terms and phrases used herein are intended to provide a comprehensible description of the invention without being limiting.

The foregoing description of the embodiments of the disclosure have been presented for the purpose of illustration; it is not intended to be exhaustive or to limit the disclosure to the precise forms disclosed. Persons skilled in the relevant art can appreciate that many modifications and variations are possible in light of the above disclosure.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

We claim:

1. An optical connector assembly, comprising:
a housing having:
a mating end shaped to receive an input connector; and
an output end opposite the mating end;
a ferrule disposed within the housing;
at least a portion of an optical cable secured within the ferrule;
a plug body in thermal contact with the ferrule and having a plug-body front face, the plug-body front face being configured to interface with a thermal pad having a thermal-pad rear face and a thermal-pad front face, wherein when in use, the thermal-pad rear face contacts the plug-body front face, the thermal-pad front face contacting the input connector when the input connector is mated to the optical connector assembly.

2. The optical connector assembly of claim 1, the thermal pad comprising one or more of silicone, silicone rubber, fiberglass, and composites thereof.

3. The optical connector assembly of claim 1, wherein:
the ferrule is shaped as a cylinder; and
the thermal pad is shaped as an annulus that encircles the ferrule.

4. The optical connector assembly of claim 3, wherein:
the plug body defines a channel that extends axially inward from the plug-body front face such that a portion of the ferrule is disposed in the channel.

5. The optical connector assembly of claim 1, further comprising a spring secured within the housing and configured to bias the plug body towards the mating end of the housing.

6. The optical connector assembly of claim 5, wherein the plug body forms a plug-body flange against which the spring exerts a force to bias the plug body towards the mating end of the housing.

7. The optical connector assembly of claim 6, the housing including a stop surface, wherein movement of the plug body toward the mating end of the housing is limited by the stop surface.

8. The optical connector assembly of claim 1, further comprising a back body located at the output end of the housing, wherein the optical cable passes through the back body.

9. The optical connector assembly of claim 8, further comprising a sealing member located between the optical cable and the back body.

10. The optical connector assembly of claim 8, further comprising a sealing member located between the back body and the housing.

11. The optical connector assembly of claim 8, further comprising:
a first sealing member located between the optical cable and the back body; and,
a second sealing member located between the back body and the housing.

12. The optical connector assembly of claim 11, one or both of the first and second sealing member being an O-ring.

13. The optical connector assembly of claim 1, the plug body defining a plug-body channel, a first portion of the optical cable located within the plug-body channel bare of an outer fiber jacket surrounding at least one optical fiber, a second portion of the optical cable located within the plug-body channel having the outer fiber jacket.

14. The optical connector assembly of claim 13, the first portion and the second portion including an inner fiber jacket surrounding the at least one optical fiber.

15. The optical connector assembly of claim 14, the at least one optical fiber being located within the ferrule and bare of the outer fiber jacket and the inner fiber jacket.

16. The optical connector assembly of claim 13, the at least one optical fiber being located within the ferrule and bare of the outer fiber jacket and the inner fiber jacket.

17. The optical connector assembly of claim 1, the ferrule and the plug body being monolithic.

18. The optical connector assembly of claim 1, internal components of the housing being sealed to external elements external to the optical connector assembly.

19. The optical connector assembly of claim 1, the thermal pad being a component of the input connector.

20. The optical connector assembly of claim 1, the optical cable having a core or bundle of light guiding or light emissive fibers.
